(19) United States
(12) Patent Application Publication
(10) Pub. No.: US 2023/0177571 A1
(43) Pub. Date: Jun. 8, 2023

(54) Method And System For Gathering And Verifying Home Information, Tools Utilizing Home Information, And Homeowner Oriented Social Data Platform

(71) Applicants: Jeff Watts, Virginia Beach, VA (US); Karen Watts, Virginia Beach, VA (US)

(72) Inventors: Jeff Watts, Virginia Beach, VA (US); Karen Watts, Virginia Beach, VA (US)

(21) Appl. No.: 17/861,793

(22) Filed: Jul. 11, 2022

Related U.S. Application Data
(60) Provisional application No. 63/221,179, filed on Jul. 13, 2021.

(51) Int. Cl. G06Q 30/0282; G06Q 30/018

(52) U.S. Cl. CPC G06Q 30/0282; G06Q 30/018

(57) ABSTRACT

A system and method for gathering, storing, and verifying data relating to real estate and persons associated with real estate, which allows for creation of specific lists and other information sets to be provided to different recipients. The system is adapted to receive data from a variety of users, partners, and data brokers. The system provides tools for the creation of outputs to users and partners based upon user requests, partner requests, analytical inference, and by triggering events. According to aspects of the invention, homeowners, supporting partners, and service providers may have access to profiles of property which include data sets not previously available in a single system, such as title reports, insurance policies, construction information, appliance and other asset information, verifying information, files and images, as well as the history including when items were last initiated or purchased, maintenance history, and identification of interacting parties. The system allows for homeowners and service providers to receive requested information, contacts, quotes, and other items based upon user requests. The system may also include a social network used to enhance user participation, motivate user interactions, and to further data input to the overall system.

### CROSS-REFERENCE TO RELATED APPLICATIONS

This application claims priority to U.S. Provisional Patent Application No. 63/221,179 to Watts et al, filed Jul. 13, 2021, which is hereby incorporated by reference in its entirety

### BACKGROUND

### Field of the Invention

The present invention relates to an improved computer system, and more specifically to method and apparatus for gathering and verifying home information, and tools utilizing such information.

### Description of Related Art

The accurate valuation and ownership of any asset requires accurate, up to date, accessible and detailed information. From fine art to equities trades—the better the data set and chain of ownership—the better the valuation of the asset both long term and in a transaction between parties.

In real estate, however, the various types of data related to a property are highly compartmentalized and are not interactive. Further, transactions with regard to a single property, especially sales transactions, may take place very infrequently, adding to the complexity of gathering and maintaining data. Typically, even the owner does not possess all information related to their property or properties.

For example, information related to property title, insurance policies, maintenance records, neighborhood information, and other aspects may be incomplete, inaccurate, or otherwise unable to be used. To the extent that such information is tracked, it may be spread across many types of companies and agencies, such as recorder's offices, insurance companies, contracting companies, and may not be able to be easily retrieved, if they have been saved at all.

What is needed is a system and method of gathering, storing, and verifying information related to real estate, such as homes. What is further needed are tools to utilize this information to facilitate interactions between homeowners and service providers. What is also needed is for such a system and method to be homeowner centered and portable to new owners as well as shareable with service providers and peer group, which may include the use of a homeowner's social network and data platform.

### BRIEF DESCRIPTION OF THE DRAWINGS

FIG. 1 is an illustration of a database for access by a homeowner oriented platform according to some embodiments of the present invention.

FIG. 2 is an illustration of a diagram of a computer system illustrating input paths according to some embodiments of the present invention.

FIG. 3 is an illustration of a diagram of a computer system illustrating output paths according to some embodiments of the present invention.

FIG. 4 is an illustration of a block diagram of a computer system according to some embodiments of the present invention.

FIG. 5 is an illustration of a block diagram of a computer system in which illustrative embodiments may be implemented.

FIG. 6 is an illustration of a web page illustrating a kitchen appliance's history according to some embodiments of the present invention.

FIG. 7 is an illustration of a flow chart of a process for generating homeowner contacts in response to a request from a service provider according to some embodiments of the present invention.

FIG. 8 is an illustration of a flow chart of a process for service provider responses in response to a request from a homeowner according to some embodiments of the present invention.

FIG. 9 is an illustration of a flow chart of a process for generating insurance or mortgage quotes or policy documents in response to a request from a homeowner according to some embodiments of the present invention.

FIG. 10 is an illustration of a flow chart of a process for verifying data input according to some embodiments of the present invention.

FIG. 11 is an illustration of a flow chart of a process for responding to a triggering event according to some embodiments of the present invention.

### SUMMARY OF THE INVENTION

A system and method for gathering, storing, and verifying data relating to real estate and persons or organizations associated with real estate, which allows for creation of specific lists and other information sets to be provided to different recipients specific to their needs and granted permissions. The system is adapted to receive, record, and track data from a variety of users, partners, and data brokers. The system provides tools for the creation of outputs to users and partners based upon user requests, partner requests, and due to triggering events that can be explicitly requested or inferred through analytics. According to aspects of the invention, homeowners may have access to profiles of their property which include data sets not previously available in a single system, such as title reports, insurance policies, construction information, appliance and other asset information, as well as the history including when items were last initiated or purchased, maintenance history, and identification of interacting parties. The system allows for homeowners and service providers to receive requested information, contacts, quotes, and other items based upon user requests. A home profile, once created, may be transferrable to a subsequent purchaser of the home, affording the new owner the benefit of the stored information. The system may also include a social network used to enhance user participation and to further data input to the overall system.

### DETAILED DESCRIPTION

Systems and methods for providing output information to users regarding real estate and interactions relating to real estate are described. An aspect of the present system is the aggregation of data related to real estate not previously seen in a single system. For example, information related to appraisals, insurance, and title may have all been separately saved at an appraiser's office, with an insurance company, and with a title company, if they were retained at all. Typically, real estate sales of a particular property occur seldom enough that such data may not be retained. Also, other information relating to the property asset, such as the type and age of the appliances, paint, roof, and other similar items, as well as where the asset or materials were purchased, and who may have provided the installation or maintenance services, have not been aggregated into a system before. Further, the information is linked such that the repair is linked to the appliance, for example, and further linked to the particular user-service provider repairperson. The aggregation and linking of this data allows for tools which provide functionalities based upon user requests or triggering events.

The present system allows for the creation of a user profile and a home profile, among other data storage methods. A user profile may comprise information about a particular homeowner, such as personal information, as well as to which and how many homes they own, which then in turn have their own home profiles. A service provider, such as a contractor, may also have a user profile, which may include data with regard to location, types of services offered, metrics on the performance of these services, listings of services provided to different homeowner-users and homes, customer satisfaction ratings, and other data. Similarly, other users may be material sales companies, insurance agents, mortgage brokers, and other persons or companies which may be associated with providing goods or services to a home or homeowner, and also associated with supporting service providers. A home profile may comprise information about a particular home, which may include construction information, appliance and other equipment information, including installation aspects such as the contractor or installer, work dates, and maintenance history, warranties, and images of the installed item and completed work. The home profile may include information about aspects both within the home and external to the home, which may include yard, landscape, driveway, attitudes of the neighbors and the community, and other types of information. Of note, a home profile may be transferred to a new homeowner-user when the property is sold, allowing the new owner to gain the benefit of knowledge of these home details. User data, in contrast, remains with the user. In some aspects, users may have access to not only their own activities, but to the activities of all users on the system. For example, in the case of a user-homeowner, that user-homeowner may access a user-service provider's history of work with other users on the system.

The present system and method also allows for verification of data, including determining whether new data input with regard to a property conflicts with the existing data. In some aspects, input data is checked against existing data for conflict. In the case of a conflict of inputted data with existing data, an internal verification process will determine which data to maintain as the present value of the inputted parameter based upon the type of data input, and based upon who has inputted it. For example, if a new input regarding the type of water heater in a home is inputted, and the input includes a picture and comes from a highly rated home technician, this may outweigh an earlier input from a real estate agent without a picture. In some aspects, when inputted data conflicts with prior data, the homeowner may receive a report from the system notifying the homeowner of the circumstance.

The flowcharts and block diagrams in the different depicted embodiments illustrate the architecture, functionality, and operation of some possible implementations of apparatuses and methods in an illustrative embodiment. In this regard, each block in the flowcharts or block diagrams may represent at least one of a module, a segment, a function, or a portion of an operation or step. For example, one or more of the blocks may be implemented as program code.

In some alternative implementations of an illustrative embodiment, the function or functions noted in the blocks may occur out of the order noted in the figures. For example, in some cases, two blocks shown in succession may be performed substantially concurrently, or the blocks may sometimes be performed in the reverse order, depending upon the functionality involved. Also, other blocks may be added, in addition to the illustrated blocks, in a flowchart or block diagram.

As used herein, the phrase “at least one of,” when used with a list of items, means different combinations of one or more of the listed items may be used and only one of each item in the list may be needed. In other words, “at least one of” means any combination of items and number of items may be used from the list, but not all of the items in the list are required. The item may be a particular object, thing, or a category.

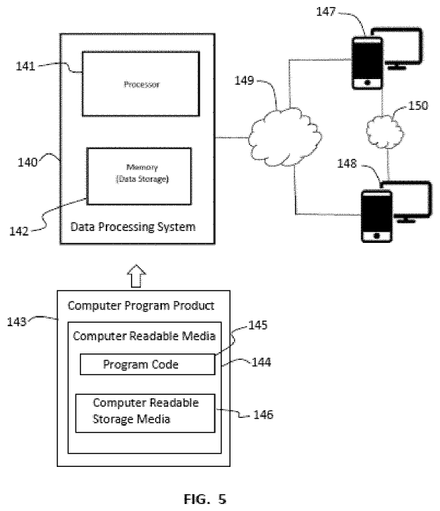

With reference now to the figures and, in particular, with reference to FIG. 5, an illustration of a diagram of a data processing environment is depicted in accordance with an illustrative embodiment. It should be appreciated that FIG. 5 is only provided as an illustration of one implementation and is not intended to imply any limitation with regard to the environments in which the different embodiments may be implemented. Many modifications to the depicted environments may be made.

The data stored as part of this system may be data that is synchronized across multiple data storage locations. The computer-readable program instructions 145 and a computer readable storage media 146 may reside in a computer readable media 144 forming a computer program product 143, which may be loaded onto a computer, a programmable data processing apparatus 140, or other device to cause a series of operational steps to be performed on the computer, a programmable apparatus, or other device to produce a computer implemented process, such that the instructions which execute on the computer, the programmable apparatus, such as a processor 141 or the other device implement the functions and/or acts specified in the flowchart and/or block diagram block or blocks utilizing data storage on one or more memory devices 142. The operational steps may be performed as distributed computing in a cloud environment.

FIG. 5 depicts a pictorial representation of a network of data processing systems in which illustrative embodiments may be implemented. The network data processing system 140 is a network of computers in which the illustrative embodiments may be implemented. The network data processing system may utilize a network 149, which is a medium used to provide communications links between various devices and computers connected together within network data processing system. The network may include connections, such as wire, wireless communication links, or fiber optic cables.

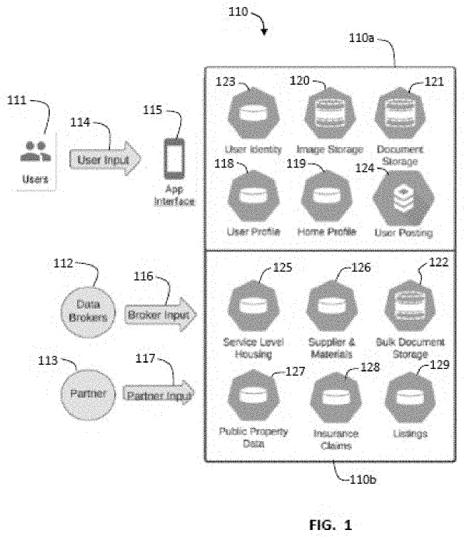

In the depicted example of FIG. 5, the network data processing system may use the Internet with the network representing a worldwide collection of networks and gateways that use the Transmission Control Protocol/Internet Protocol (TCP/IP) suite of protocols to communicate with one another. At the heart of the Internet is a backbone of high-speed data communication lines between major nodes or host computers consisting of thousands, or significantly more, of commercial, governmental, educational, and other computer systems that route data and messages. Of course, network data processing system also may be implemented as a number of different types of networks, such as, for example, an intranet, a local area network (LAN), or a wide area network (WAN). FIG. 1 is intended as an example, and not as an architectural limitation for the different illustrative embodiments. In some aspects, a user may communicate with the system using a network compatible device 147, 148 which may be a cellular telephone, computer, or other device. In some aspects, differing users may also communicate between their network compatible devices 147, 148 using a network 150. In some aspects, the user device may contain code specific to the system, such as an application programming interface (API), and thus the user device itself may be viewed as part of the overall data processing system.

Referring to FIG. 1, for example, Document Storage 121 and Bulk Document Storage 122, as well as the other data, may be stored on storage devices. A storage device is any piece of hardware that is capable of storing information, such as, for example, without limitation, at least one of data, program code in functional form, or other suitable information either on a temporary basis, a permanent basis, or both on a temporary basis and a permanent basis. Storage devices may also be referred to as computer-readable storage devices in these illustrative examples. Persistent storage may take various forms, depending on the particular implementation.

For example, persistent storage may contain one or more components or devices. For example, persistent storage may be a hard drive, a flash memory, a rewritable optical disk, a rewritable magnetic tape, or some combination of the above. The media used by persistent storage also may be removable. For example, a removable hard drive may be used for persistent storage.

As discussed above, the present system aggregates types of previously disparate data to provide functionalities as described herein. FIG. 1 illustrates types of data 110 as it would reside at rest, according to some embodiments of the present invention. The data may be stored on at least one of a hard drive, a flash memory, a rewritable optical disk, a rewritable magnetic tape, or some combination of the above, or other appropriate means. FIG. 1 further illustrates the types of inputs which may inputted to populate the data storage aspects, as well as the types of entities which may input data.

Users 111 may include homeowners, business users (such as contractors, technicians, landscapers, etc), and others who provide user input 114 via an application interface 115, which may be a cellular telephone, mobile device, computer, or other device. User input data may be stored as different categories of data 110a, with an individual data point residing in more than one location, depending on type. Examples of user data include images, documents, social media postings, and others. Home profile data 119 may include all information relating to particular home, which may include location, size, square footage, number and types of rooms, appliances, roof type, paint type and color, as well as all maintenance and repair records. Uploaded documents may reside in a document storage area 121, although information from those documents may also be found in the home profile data 119 as well as the user profile data 118. It is to be understood that the home or user profile data areas may contain such differentiated data for numerous homes. User profile data 116 may include information relating to a particular user, which may be a homeowner-user or a service provider-user, for example. Images uploaded by a user 111 may be stored in an image storage area 120, although information from those images may also be found in the home profile data 119 as well as the user profile data 118. Postings made in the social media aspect of the present system, which are input by users 111, are considered user input 115 and are stored in the user posting data area 124. Further user identity data 123 may be stored separately, which may include information segregated for reasons of confidentiality or other reasons.

Data brokers 112 may provide broker input 116 which may include listings information, title information, and other types of data. Certain data 125 may have service level restrictions, which may restrict further transmission of the raw data, and this data may be stored as service level housing data 125. Public property data, such as public information from recorder's offices, may be stored as public property data 127. Listings data 129 may be stored as listings data 129. Any unrestricted data may also be stored in the bulk document storage bin 122.

Partners 113 may provide partner input 117, which may be stored in bulk document storage 122, and other appropriate data stores. For example, an insurance company partner may provide claims data which may be stored in the insurance claims data 128. Partners may also include large material suppliers, such as home furnishing suppliers, appliance retailers, and the like, and they may provide data about such items that is stored in the supplier and materials area 126. Although an insurance company may be a partner, an individual insurance agent may be a user. Similarly, as a large mortgage company may be a partner, an individual mortgage broker may be a user. In some aspects, these lines my be drawn at different levels.

Although user data 110a, and broker and partner data 110b, are illustrated as partitioned in FIG. 1, it is to be understood that there may intermingling of the two categories of data. For example, broker input 116 from data brokers 112 may be used to populate aspects of the home profile 119 of a particular property.

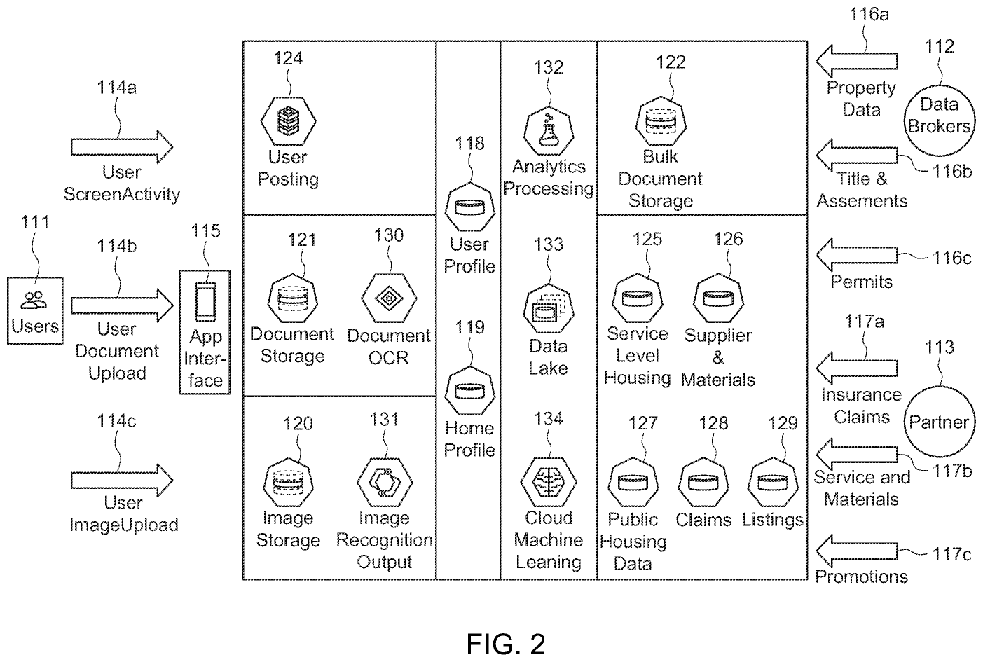

FIG. 2 illustrates further detail of the data inputs seen in FIG. 1, with additional aspects of the system, according to some embodiments of the present invention. The data may be stored on at least one of a hard drive, a flash memory, a rewritable optical disk, a rewritable magnetic tape, or some combination of the above, or other appropriate means. FIG. 2 illustrates additional detail the types of inputs which may be inputted to populate the data storage aspects from the different types of entities which may input data. A user 111 may have screen activity 114a which are stored in the user posting data area 124. A user 111 may upload a document 114b which is stored in the document storage 121. Documents may run through document optical character recognition 130, which may then provide data for storage in the user profile 118 and/or the home profile 119. A user 111 may upload an image 114c which may be stored in the image storage 120. Images may run through an image recognition program with image recognition output 131 stored, which then also may be forwarded and stored all or in part in the user profile 118 and/or the home profile 119. Data brokers 112 may input property data 116a, title and assessments information 116b, and permit information 116c, which may be stored in the bulk document storage 122. Partners 113 may input insurance claims 117, as may be the case with an insurance company partner. Partners 113 may input service and materials information 117b, and promotions information 117c. The system may include analytics processing 132 and cloud machine learning 134, which may utilize a data lake 133.

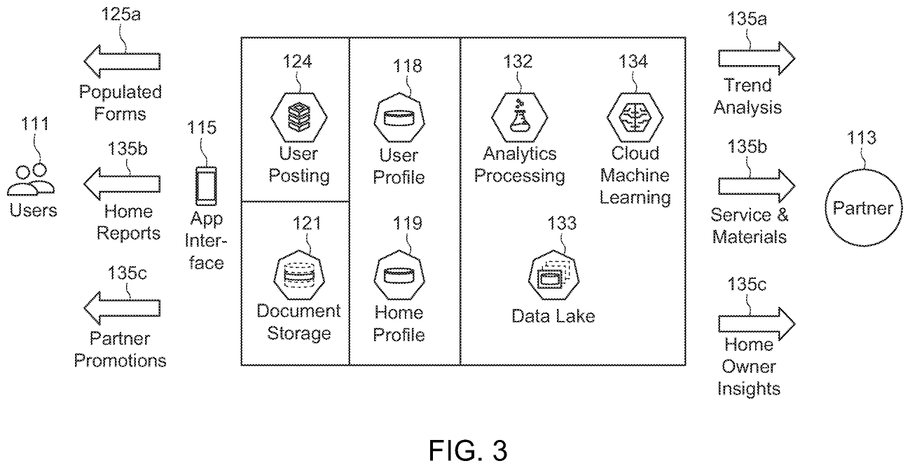

FIG. 3 illustrates output deliverables provided by the system according to some embodiments of the present invention. With regard to processes providing the outputs seen in FIG. 3, the user profiles 118 and the home profiles 119 are coupled with a data lake 133, an analytics processing portion 132, and a cloud machine learning portion 134. A user 111 may utilize an application interface 115 to generate and receive a home report 135b, which may include data elements previously described above. The system may also provide partner promotions 135c to the user 111. For example, a partner may have requested a determination of all homeowner-users which have a wood or composite shingle roof over 10 years old (as a simple illustrative example), and the system then generates a list of all such users. The partner may be desiring to relay information about roofing services, roofing supplies, and/or pricing discounts on such services and/or goods. The system then facilitates an output communication about the partner promotion 135c to the selected users 111. In some aspects, the partners may be provided with the contact information of the selected users 111 for direct contact by the partner. The user 111 may also receive populated forms 125a, such as insurance or mortgage applications, in response to a request for insurance or mortgage policy support.

Similarly, a partner 113 may receive outputs generated in response to a request from the partner 113. Using the aforementioned user profiles 118 and the home profiles 119 coupled with a data lake 133, an analytics processing portion 132, and a cloud machine learning portion 134, a partner may receive a trend analysis 135a, a tailored set of homeowner insights 135c, and/or information with regard to services and materials 135b.

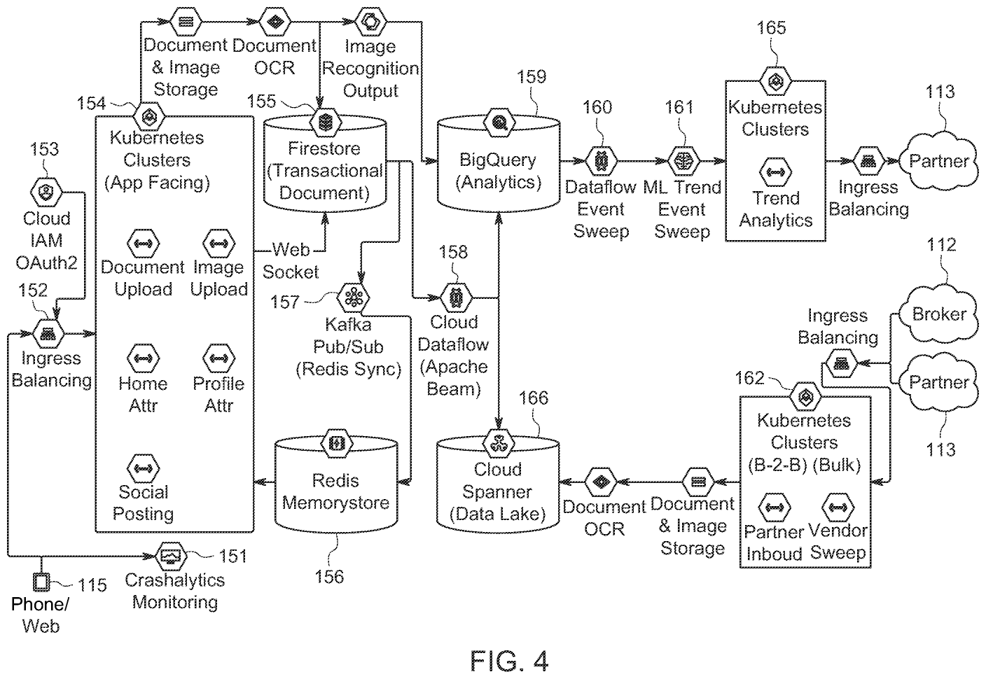

FIG. 4 illustrates a integration architecture diagram according to some embodiments of the present invention. An application facing Kubernetes cluster 154 runs containerized applications. A user interface 115, such as a phone or computer, is coupled into the system through ingress balancing 152. In some aspects, the user device may contain code, such as an application programming interface (API), and itself may be viewed as part of the overall system. A realtime crash reporting tool 151 couples to the ingress balancer 152, as does a cloud identity and access management module 153. A Firestore database 155 with unstructured interleaved data may be synched 157 to a Redis Memorystore 156, in both directions. An analytics module 159 couples to a dataflow event sweep 160 to a ML trend event sweep 161 and then to a Kubernetics cluster 165. The dataflow event sweep 160 is where the event data (for example, new housing data, new claims data, new user information, etc.) is analyzed and routed to its specific data store. The ML Trend Event Sweep 161 where machine learning APIs perform trend analysis, linguistics functions, image recognition, and synchronization prioritization, for example. The output data from the trend analytics 160 may route through balancing to Partners 113. Partner 113 and broker 112 input enters via ingress balancing to a Kubernetics cluster 162, which may contain a vendor sweep 163 and partner I/O 164, routing to a Cloud Spanner data lake 166. The Analytics module 159 couples to the Data Lake 166, which may provide access to raw data. Cluster 165 propagates analytic outputs to the Partners. Kebernetes cluster 162 receives inputs form Brokers 112 and Partners 113 for ultimate routing to the Data Lake 166. The flowcharts and block diagrams in the different depicted embodiments illustrate the architecture, functionality, and operation of some possible implementations of apparatuses and methods in an illustrative embodiment.

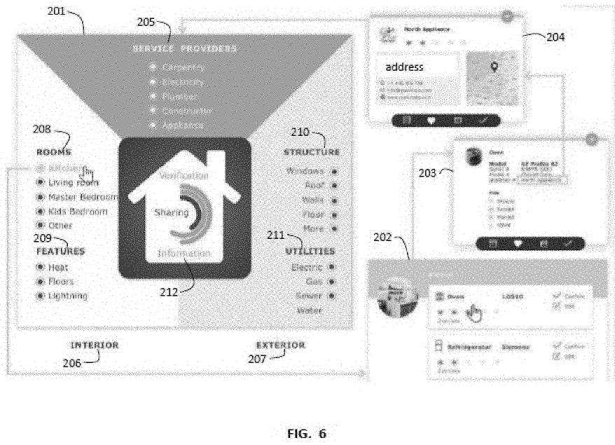

FIG. 6 illustrates a exemplary web page 201 as may be viewed by a user-homeowner, for example. In this illustrative example, the user-homeowner may click/select different information types for query, which represent an information request to the system. The user-homeowner may inquire about types of service providers 205. In this subset of providers, home building and maintenance type services are highlighted. The user-homeowner may inquire about a room 208, feature types 209, structure aspects 210, and utilities 211, which may have been segregated into interior 206 and exterior 207 aspects. By having selected the “kitchen” choice under rooms 208, the user-homeowner may see the various appliance types in the kitchen 202, and other kitchen information. By having then selected the “oven” choice, the oven appliance model information 203 is then delivered for view by the user-homeowner. The installer may be seen in the oven data 203, and when selected for query the system then may provide information about the sales and/or installation company 204. This information screen may include a confirm option and an edit function to allow for verification or modification of data. Although this information may be accessed by the user-homeowner, it may be understood that a potential purchaser of the home may be granted access to allow for similar delivery of this information to the prospective purchaser.

Referring back to the various types of input data seen in FIGS. 1 and 2, the broader data (location, square footage, room types, etc) can be augmented, refined and expanded directly by the homeowners who track services, maintenance, documentation, videos, images, warranties, features and improvements as they add them to their home. Similar data can be called up and delivered with regard to disclosures, permits, improvements, sales prices, financing and insurance activity on any property. In some aspects, the homeowner is in control of how the data is gathered and shared to assure both privacy and relevance. With this capability all users are able not only to see a data point on a home (such as an appliance) but also the supporting files as to its make, model, condition, supporting retailer, installer, and warranties, for example.

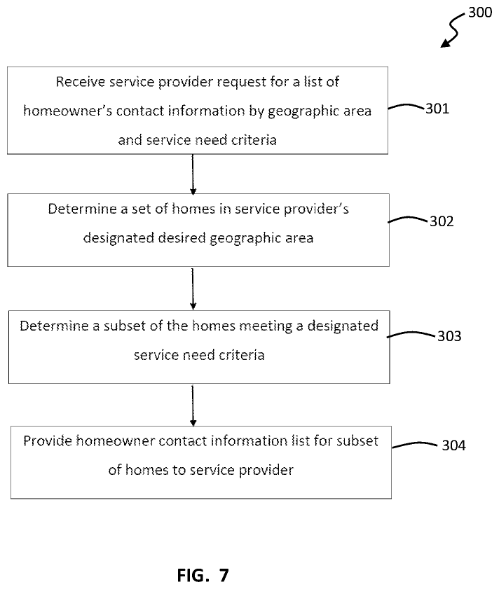

Turning to FIG. 7, an illustration of a flowchart of a method 300 for creating a list of homeowner targets in response to a request by a service provider-user in accordance with an illustrative embodiment. Method 300 can be implemented in software, hardware, or a combination of the two. When software is used, the software comprises program code that can be loaded from a storage device and run by a processor unit in a computer system as described herein. Method 300 receives a service provider request 301 desiring that a list of homeowners be created that meets a targeted need, such as all homes in a defined geographic region which have not been repainted in the last five years, for example. Method 300 aggregates, by one or more processors, a list of all homes in the defined geographic area (operation 302). Method 300 refines, by one or more processors, the list to narrow to homes which have not been repainted in the last five years (operation 303). In some aspects, only homeowner-users have opted in for communications are selected. Method 300 then provides, by one or more processors, a list of the selected homes to the service provider (operation 304). In some aspects, the system will provide direct contact information to the service provider who had made the request. In some aspects, the system will facilitate the contact directly.

In some aspects, A computer implemented method comprising: receiving, at a server from a consumer device, a request from a system user-homeowner for a service, contracting, or equipment need; determining, by the server, a set of user-service providers or partners available to provide the requested service; determining, by the server, a ranking of said user-service providers based upon reputational score of said user-service provider; providing, by the server, a list of user-service providers available to provide the requested service.

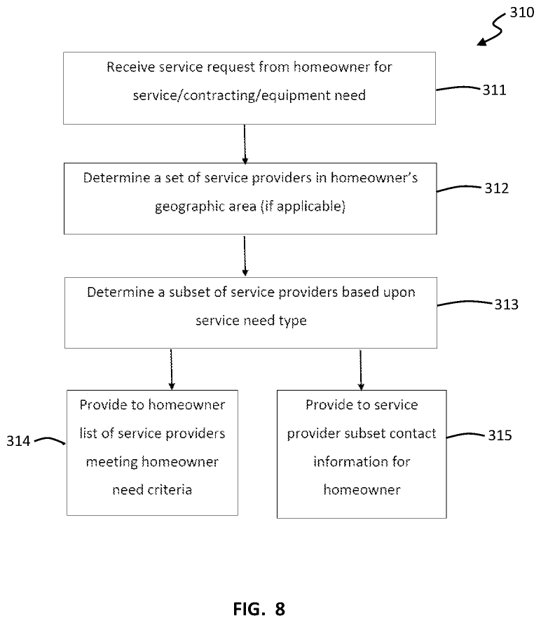

FIG. 8 illustrates a flowchart of a method 310 for creating a list of service providers in response to a request by a homeowner-user in accordance with an illustrative embodiment. In some aspects, the request may be that this selected list make direct contact with the homeowner. Method 310 can be implemented in software, hardware, or a combination of the two. When software is used, the software comprises program code that can be loaded from a storage device and run by a processor unit in a computer system as described herein. Method 310 receives a homeowner request 311 desiring a list of service provider that meets a specified need, such as house painters with a high reputational rating, for example. Method 310 aggregates, by one or more processors, a list of all such service providers in the homeowner's geographic area (operation 312). Method 310 refines, by one or more processors, the list to narrow to service providers with a high reputational rating, if included in the request (operation 313). Method 310 then provides, by one or more processors, a list of the selected service providers to the homeowner (operation 314). In some aspects, system may provide the homeowner-user a ranking of the service providers based upon homeowner preferences and/or service provider history. In some aspects, the system will provide direct contact information to the service providers selected who can then contact the homeowner. In some aspects, the system will facilitate the contact directly. In some aspects, the system will further provide analytically derived recommendations based upon the attributes of both the homeowner and the service providers.

In some aspects, A computer implemented method comprising: receiving, at a server from a consumer device, a request from a system user-homeowner for a service, contracting, or equipment need; determining, by the server, a set of user-service providers or partners available to provide the requested service; determining, by the server, a ranking of said user-service providers based upon reputational score of said user-service provider; providing, by the server, a list of user-service providers available to provide the requested service.

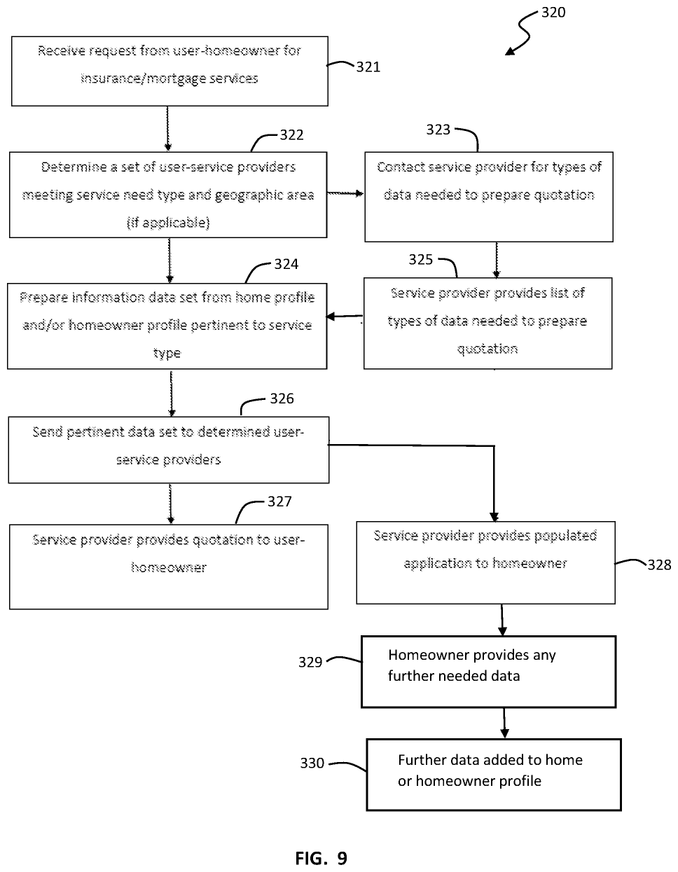

FIG. 9 illustrates a flowchart of a method 320 for creating a list of mortgage or insurance service providers in response to a request by a homeowner-user in accordance with an illustrative embodiment. Method 320 can be implemented in software, hardware, or a combination of the two. When software is used, the software comprises program code that can be loaded from a storage device and run by a processor unit in a computer system as described herein. Method 320 receives a homeowner request 321 desiring a list of service providers that meets a specified need, such as earthquake insurance, or a mortgage refinance, for example. Method 320 aggregates, by one or more processors, a list of all such service providers in the homeowner's geographic area (operation 322), or as applicable depending on service type. Method 320 prepares, by one or more processors, an information dataset from the home profile and/or homeowner profile pertinent to the request type (operation 324). In some aspects, method 320 may first prepare an information data set of the expected pertinent data (operations 324), which may be a standardized and pre-set information set, and send them a list of selected appropriate service providers (operation 326). If the data was sufficient, the service provider(s) may then provide a quotation or completed application to the user-homeowner (operation 327). If the data supplied was not complete enough for the service provider(s), the service provider(s) may provide a partially populated application to the homeowner (operation 328. The homeowner may then provide any further needed data (operation 329). Method 320 may then save the further data added into the homeowner's user profile (operation 330).

In some aspects, method 320 may contact them to confirm what types of data are needed to provide the service quotation or application (operation 323). The service provider(s) may the provide a list of further needed data for quotation or application preparation, if any (operation 325).

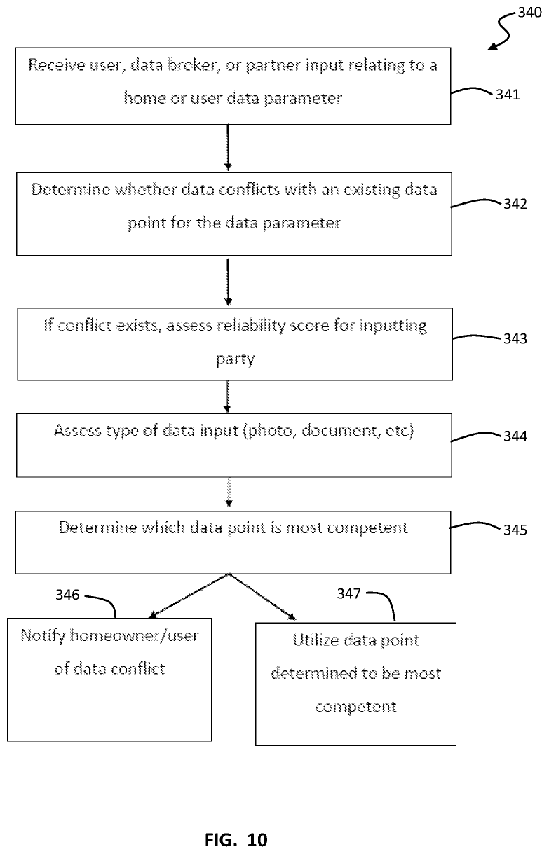

FIG. 10 illustrates a flowchart of a method 340 for verifying input relating to a home or user in response to an input from a homeowner-user or a service provider-user (or other input) in accordance with an illustrative embodiment. Method 340 can be implemented in software, hardware, or a combination of the two. When software is used, the software comprises program code that can be loaded from a storage device and run by a processor unit in a computer system as described herein. Method 340 receives an input relating to a home or user parameter 321. Method 340 determines, by one or more processors, whether the data input conflicts with an existing data point for the data parameter (operation 342). If a conflict exists, method 340 determines, by one or more processors, a reliability score for the inputting user (operation 343). Method 340 assesses what type of data input was made (photo, document, post, for example) to determine a reliability score for the type of input (operation 344). Method 340 determines, by one or more processors, which data point is the most competent by comparing the overall reliability of the new input vs. the existing data (operation 345). Method 340 utilizes the data point determined to be most competent (operation 347). Method 340 notifies, by one or more processors, the user-homeowner or other appropriate user of the data conflict (operation 345). In some aspects, the user may request that all conflicts be reported to the user. In some aspects, the user may request that the system resolve such conflicts. In some aspects, a mix of both approaches may be used. In some aspects, the data point conflict may remain unresolved, and may be flagged as such.

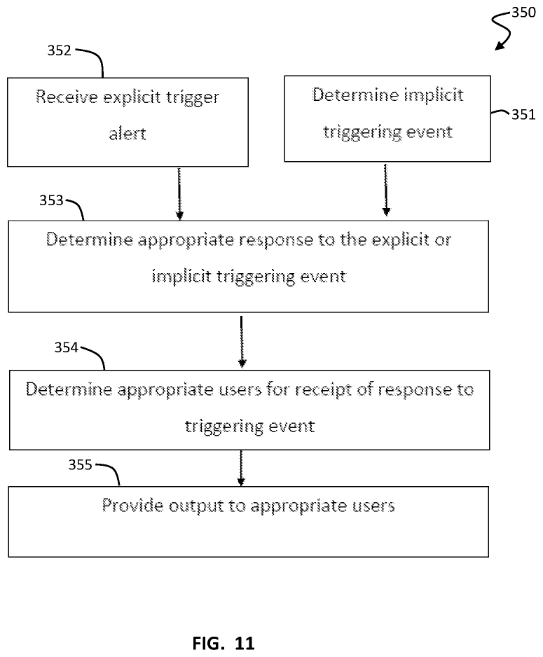

FIG. 11 illustrates a flowchart of a method 350 for providing a response output to a homeowner-user or a service provider-user in response to a trigger event input in accordance with an illustrative embodiment. Method 350 can be implemented in software, hardware, or a combination of the two. When software is used, the software comprises program code that can be loaded from a storage device and run by a processor unit in a computer system as described herein. Method 350 may receive an input relating to a home or user parameter which is seen as an explicit trigger 321. In some aspects, the input which is the explicit trigger may be a user provided input, such as a notification of a new child, a retirement, notification of a move to a new home, an insurance claim filing, and the like. In some aspects, the explicit trigger may not be specific to the home or user, such as a severe weather event in the region, such as a hurricane or tornado. Method 350 the determines the appropriate response to the trigger event (operation 353). For example, if a geographic region is hit by a severe hurricane, partners who provide claims adjustment, or provide cleanup and repair services, may want to contact homeowner-users in the affected region. In some aspects, the system may contact the partners to notify them of the opportunity to contact homeowner-users. In some aspects, the partners may then provide service offers to appropriate recipient home-owner users. In another example, as with the triggering input of the announcement of a new child, the system may contact partners who may desire to contact the homeowner-user with offers of baby furniture and the like. In the case of a regional trigger, such as with a storm, method 350 determines the appropriate user-homeowners for receipt of the response from the partners (operation 354). In the case of an explicit trigger relating to a particular homeowner-user, the appropriate user-homeowner for receipt of the response may be that single homeowner-user. Method 350 then provides, by one or more processors, a list of the selected service providers to the homeowner (operation 355). In some aspects, the system will provide direct contact information to the service providers selected who can then contact the homeowner. In some aspects, the system will facilitate the contact directly.

In addition to the aforementioned methods and functionalities, in some aspects the system will include a social media aspect which allows for posting about homes, services, and other experiences. Social media posts may be saved, with user permission, and add an interactive and social aspect to the overall system, which may bring a number of benefits. For example, the social media aspect may enhance user participation, may enhance user enjoyment, and further the amount of data input into the overall system.

As evident from the above description, a wide variety of embodiments may be configured from the description given herein and additional advantages and modifications will readily occur to those skilled in the art. The invention in its broader aspects is, therefore, not limited to the specific details and illustrative examples shown and described. Accordingly, departures from such details may be made without departing from the spirit or scope of the applicant's general invention.

What is claimed is:

1. A computer implemented method comprising:
receiving, at a server from a consumer device, a request from a system user-homeowner for a service, contracting, or equipment need;
determining, by the server, a set of user-service providers or partners available to provide the requested service;
determining, by the server, a ranking of said user-service providers based upon reputational score of said user-service provider; and
providing, by the server, a list of user-service providers available to provide the requested service.

2. The computer implemented method of claim 1 further comprising contacting, by the server, the user-service providers on said list to facilitate contact of the user-homeowner by the user-service provider.

3. The computer implemented method of claim 1 further comprising providing to the homeowner said list of user-service providers meeting the needs of the request.

4. A computer implemented method comprising:
receiving, at a server from a consumer device, a request from a system user-service provider or partner for a list of homeowners by geographic area and service need criteria;
determining, by the server, a set of homes in the designated geographic area;
determining, by the server, a list of a subset of said homes meeting the designate service need criteria, said homes affiliated to a user-homeowner; and
providing to the user-service provider or partner, by the server, the contact information for the subset of user-homeowners available meeting said criteria.

5. A computer implemented method comprising:
receiving, at a server from a consumer device, a request from a system user-homeowner for an insurance or mortgage service need;
determining, by the server, a set of user-service providers or partners available to provide the requested service;
preparing, by the server, an information dataset from the user-homeowner's profile and home profile pertinent to the requested service type; and
sending, by the server, the prepared information dataset to the set of user-service providers or partners available to provide the requested service;
thereby facilitating the provision of said service to the user-homeowner.

6. The computer implemented method of claim 5 further comprising populating, by the server, an application for the requested service type.

7. The computer implemented method of claim 6 further comprising sending, by the server, the populate application for the requested service type to the set of user-service providers or partners.

8. A computer implemented method for facilitating homeowner oriented transactions, the method comprising:
aggregating, by one or more processors, home data regarding a plurality of factors associated with a plurality of homes;
aggregating, by one of more processors, service provider data regarding a plurality of factors associated with service provides providing services to homeowners;
receiving a request for a service type by the owner of one said plurality of homes;
determining, by the server, a set of user-service providers or partners available to provide the requested service;
determining, by the server, a ranking of said user-service providers based upon reputational score of said user-service provider; and
providing, by the server, a list of user-service providers available to provide the requested service.

9. The computer implemented method of claim 8 further comprising contacting, by the server, the user-service providers on said list to facilitate contact of the user-homeowner by the user-service provider.

10. The computer implemented method of claim 9 further comprising providing to the homeowner said list of user-service providers meeting the needs of the request.

11. A computer implemented method for facilitating homeowner oriented transactions, the method comprising:
aggregating, by one or more processors, home data regarding a plurality of factors associated with a plurality of homes;
aggregating, by one of more processors, service provider data regarding a plurality of factors associated with service provides providing services to homeowners;
receiving, at a server from a consumer device, a request from a system user-service provider or partner for a list of homeowners by geographic area and service need criteria;
determining, by the server, a set of homes in the designated geographic area;
determining, by the server, a list of a subset of said homes meeting the designate service need criteria, said homes affiliated to a user-homeowner; and
providing to the user-service provider or partner, by the server, the contact information for the subset of user-homeowners available meeting said criteria.

12. One or more non-transitory computer-readable storage media storing compute-executable instructions, which when executed by one or more computers of a server, cause the one or more computers to perform operations comprising:
receiving a request for a service type by the owner of one said plurality of homes;
determining, by the server, a set of user-service providers or partners available to provide the requested service;
determining, by the server, a ranking of said user-service providers based upon reputational score of said user-service provider; and
providing, by the server, a list of user-service providers available to provide the requested service.

13. One or more non-transitory computer-readable storage media storing compute-executable instructions, which when executed by one or more computers of a server, cause the one or more computers to perform operations comprising:
receiving, at a server from a consumer device, a request from a system user-service provider or partner for a list of homeowners by geographic area and service need criteria;
determining, by the server, a set of homes in the designated geographic area;
determining, by the server, a list of a subset of said homes meeting the designate service need criteria, said homes affiliated to a user-homeowner; and
providing to the user-service provider or partner, by the server, the contact information for the subset of user-homeowners available meeting said criteria.
